(19) United States
(12) Patent Application Publication
(10) Pub. No.: US 2004/0233923 A1
(43) Pub. Date: Nov. 25, 2004

(54) Method and system for transmitting data from a first data network into a second data network

(76) Inventors: Gerhard Fally, Vienna (AT); Richard Jurkovicts, Katzelsdorf (AT); Robert Morelj, Munich (DE)

Correspondence Address: STAAS & HALSEY LLP, SUITE 700, 1201 NEW YORK AVENUE, N.W., WASHINGTON, DC, 20005, US

(21) Appl. No.: 10/484,160

(22) PCT Filed: Jul. 10, 2002
(86) PCT No.: PCT/EP02/07675

(30) Foreign Application Priority Data
Jul. 20, 2001 (EP) 0116763.2

(51) Int. Cl. H04L 12/28

(52) U.S. Cl. 370/412

(57) ABSTRACT

Data packets which in addition to useful information, contain an item of information concerning the temporal sequence thereof, are transmitted from a first data network to a second data network. The reading out of the buffered data is initiated at a predeterminable location that is independent of the storage segmentation that results from the storage of data packets and is thus particularly suited for efficiently transmitting RTP data packets.

### CROSS REFERENCE TO RELATED APPLICATIONS

This application is based on and hereby claims priority to European Application No. 01116763.2 filed on Jul. 20, 2001, the contents of which are hereby incorporated by reference.

### BACKGROUND OF THE INVENTION

A method is specified for transmission of data from a first data network to a second data network, in which

the data in the first data network is subdivided into packets,

each data packet includes not only the payload data but also information about the time sequence which is provided in the second data network, in particular a time stamp and/or a sequence number, and

the data packets are temporarily stored in a memory device on the basis of this time sequence.

the process of reading the temporarily stored data is started with a data packet which can be predetermined.

A system for carrying out the method is also specified.

According to the prior art, data is frequently transmitted in packets in data networks. The existing standards for data transmission in this case specify as essential neither continuous transmission of the data packets nor transmission of the data packets in the correct time sequence.

In order to make it possible to reproduce the correct time sequence of the data packets in the receiver, however, the data packets contain in addition to the payload information, a time stamp, for example, which generally indicates the time of origin of the data. In addition, a sequence number may also be transmitted in the data packet, and this represents a second criterion for sorting.

The correct time sequence is particularly important in the case of speech, video and audio data, for which reason corresponding sequencing is required in the receiver in this case, if the transmission takes place using data packets. Ideally, a continuous data stream is produced as the result in the receiver. The speech, audio or video data can thus be reproduced without any major disturbances.

Transmission in accordance with the “Real Time Transport Protocol”, RTP for short, and which has been specified by the “Internet Engineering Task Force”, IETF for short, is cited as being representative of the large number of existing standards. The standard is described in “IETF RFC 1889: RTP: A Transport Protocol for Real Time Applications”.

The components of an RTP packet include not only a time stamp and sequence numbering but also information about the type of payload data, which is also known by the expression “Payload Type”. Examples of the payload data include data in accordance with the standards “ITU G.711: Pulse code modulation (PCM) of voice frequencies”, “ITU G.723.1: Dual rate speech coder for multimedia communications transmitting at 5.3 and 6.3 kbits/s” and “ITU G.723.1 Annex A: Silence compression scheme”.

The discontinuous and unorganized arrival of the data packets when the data is transmitted between two different data networks thus leads to difficulties, since a continuous and organized data stream must be produced from the individual packets.

### SUMMARY OF THE INVENTION

An object of the invention is thus to specify a method and a system which allow data to be transmitted from a first data network to a second data network in a particularly efficient manner.

This object of the invention is achieved by a method of the type mentioned initially, in which the starting point for the reading process is located at any desired point in the data packet.

With regard to the storage process, the memory device is thus regarded as a memory which is segmented but is essentially unsegmented with regard to the reading process. Since the data items in the temporary memory have different time rankings and the method according to the invention allows the process of reading the temporarily stored data to be started at any desired point in the memory device, the data can be output with any desired time ranking and at any desired time. The shortest time unit is in this case the duration of one sample. Depending on the time resolution of the data which is transmitted in the packets, access which is more or less virtually continuous in time is thus possible.

Depending on the standard which is used, the data in the temporary memory in this case corresponds, for example, directly to the data which is received from the first network or which is produced synthetically with the aid of the data which has been received from the first network.

The invention relates not only to data networks in the relatively narrow sense, but, in particular, also to individual data lines, that is to say to the simplest form of a data network.

In general, with regard to the method according to the invention, it can be stated that sorting by a pointer technique is also possible in addition to sorting by the occupancy of successive memory areas. In the case of the latter variant, the need for occupancy of successive memory areas is dispensed with in order to achieve a fast storage process. Instead of this, the sorting process when this technique is used is produced by pointers which refer to the individual memory blocks.

Furthermore, a data packet is generally temporarily stored only when this is possible on the basis of the size of the memory device so that data packets which have not yet been transmitted are not destroyed by the temporary storage of another packet.

It is advantageous for the memory which is released by the transmission of a data packet to the second data network to be made available once again in the memory device for a newly arriving data packet. This makes optimum use of the available resources. In this case, a data packet can be physically deleted from the memory device, or else may just be marked as being deleted when the data contained in this packet is no longer required for reading.

It is advantageous

if data is transmitted to the second data network at a time which is defined by adding a delay time, which can be predetermined, to the time ranking of the data, and

if the starting point for the reading of the temporarily stored data in the memory device is chosen on the basis of this condition.

Thus, in normal operating conditions, the data is read from the memory device and is transmitted to the second data network at a time which is defined by the addition of a delay time, which can be predetermined, to the time ranking of the data. The reference to a delay time which can be predetermined results in a simple algorithm for determination of the transmission time, and the behavior of the transmission method can be predicted particularly well.

Normal operating conditions occur when, on the basis of the engineering configuration of the components which are involved in the transmission method, it is possible at a specific time to equalize the time differences which occur on the basis of the discontinuous and unorganized transmission and to reproduce the correct sequence of the data packets, thus resulting in an organized, essentially continuous data stream. The times at which the data packets are transmitted are in this case subject to operational and system-intrinsic tolerances.

A method is also advantageous in which data is produced synthetically when the calculated time for the transmission of the data is in the future with respect to the actual system time and there is no data with this time ranking in the temporary memory.

The time interval between the actual system time and the time from which data is once again available in the temporary memory for transmission to the second data network is thus advantageously bridged by artificially produced data. The synthetic production of data per se is, however, not a part of the method according to the invention.

It is also particularly advantageous,

if the delay time is shortened when a data packet is received too late to allow it to be temporarily stored, and

if the delay time is lengthened when a data packet is received too early to allow it to be temporarily stored.

This refinement of the invention also makes it possible, in particular, to handle system states in which normal operating conditions in the sense of the production of an organized, essentially continuous, data stream exist only to a restricted extent, because a data packet cannot be stored on the basis of the engineering configuration of the memory device. The delay time in this case may be automatically matched to the actually prevailing conditions, thus making it easier to produce a continuous data stream from the received data packets.

One advantageous refinement of the invention is also provided by a variant in which the temporarily stored data is read at time intervals which can be predetermined, in particular at fixed time intervals, independently of the times of temporary storage. This provides a comparatively simple mechanism for determination of the times for reading the data.

One advantageous variant of the invention is also provided

when, in addition to the time stamp, a packet has a sequence number,

when the memory device is configured with a number of parts,

when the header information in the data packets is stored in a header information memory sorted on the basis of the sequence number of the data packets, and

when the payload data in the data packets is stored in a payload information memory sorted on the basis of the time stamps for the data packets.

The logical subdivision of payload and header data, which is achieved partially by the configuration of the data packets, is thus mapped in a simple manner onto the structure of the memory device which is required for temporary storage of the data packets. The correct sequence of the data packets is taken into account at the same time as the storage process.

It is advantageous

if a magnitude is calculated for the time difference between the time stamp for a packet and the actual system time at which this packet is manipulated,

if a synchronization process is initiated when a threshold value which can be predetermined is exceeded on the basis of this magnitude, and

if the memory device is initialized during the synchronization process.

The magnitude may itself also be recalculated during this synchronization process, and in particular may be reset to zero. This refinement of the invention also makes it possible, in particular, to handle system states in which normal operating conditions in the sense of the production of an organized essentially continuous, data stream do not exist. These states may occur, for example, when, owing to the engineering configuration of the components which are involved in the transmission method, it is no longer possible at a specific time to equalize the time differences which occur on the basis of the discontinuous and unorganized transmission, and to reproduce the correct sequence of the data packets.

One advantageous refinement of the method according to the invention is also provided

if the difference between an average reception delay and a nominal reception delay is provided as the magnitude for initiation of a synchronization process,

if an actual reception delay between the system time for the reception time of an arriving new packet and the time stamp for this new packet is determined, and

if the average reception delay is calculated over all of the actual reception delays as calculated in this way, for a number, which can be predetermined, of packets which have already arrived.

A synchronization process is initiated in this way, and thus, if necessary, also matching of the processes which take place during the transmission method to the conditions which result from the discontinuous and unorganized arrival of the data packets. Although the mechanism is formed from simple mathematical operations, the averaging process nevertheless, however, allows equalization for individual time differences which would in their own right initiate a synchronization process, for example because their value differs from the average.

It is also advantageous for the nominal reception delay to be set to be equal to the average reception delay when a new packet cannot be stored in the memory device. This also takes account of the situation in which, by virtue of its engineering configuration, the memory device does not allow the temporary storage of a data packet until it is transmitted to the second data network. The memory device may be in the form of a ring memory, so that its length represents a significant factor in the occurrence of the situation that has been mentioned.

A method is also particularly advantageous

in which the nominal reception delay during a synchronization process is set to be equal to the time difference between the actual system time and the time stamp for the most recently received packet, and

in which the average reception delay during the synchronization process is set to be equal to the nominal reception delay.

The initialization of the parameters which govern the initiation of a synchronization process is thus achieved by the use of simple mathematical operations.

The above object of the invention is also achieved by a system which is provided for carrying out the method according to the invention, and

in which the system has an input module for reception of data from the first data network,

in which an output module is provided for transmission of data to the second data network,

in which the system has a synchronization module,

in which a memory device is provided for storage of data packets on the basis of their time sequence, and

in which the system reads the temporarily stored data at a point in the memory device which can be predetermined, with the starting point for the reading process being located at any desired point in the data packet.

The logical subdivision of the tasks which result from carrying out the method, that is to say reception or temporary storage and transmission or reading of data packets, as well as synchronization, is thus advantageously mapped onto functional blocks. Any fault search which may be required, can thus be carried out comparatively easily.

The memory device is essentially regarded as an unsegmented memory with regard to the process of reading in the system according to the invention. It is thus possible to output data with any desired time ranking and at any desired time, with the shortest time unit in this case being defined by the duration of one sample.

It should also be mentioned that the advantages which have been mentioned for the method according to the invention also apply equally to the system according to the invention.

It is also advantageous

if the memory device is configured with a number of parts,

if a header information memory is provided for the storage of header information for the data packets on the basis of the sequence numbering of the data packets, and

if a payload information memory is provided for the storage of the payload data in the data packets on the basis of the time stamps of the data packets.

The logical subdivision of payload and header data, which is partially provided by the configuration of the data packets, is thus mapped in a simple manner onto the structure of the memory device which is required for the temporary storage of the data packets.

It is particularly advantageous

to provide for calculation of a magnitude for the time difference between the time stamp for a packet and the actual system time at which this packet is manipulated,

to provide for initiation of a synchronization process if a threshold value, which can be predetermined, for this magnitude is exceeded, and

to provide for initialization of the memory device during the synchronization process.

The system thus can be used comparatively easily to initiate a synchronization process.

in a further advantageous variant, the output module provides for synthetic production of data.

A time interval in which there is no data in the temporary memory for transmission to the second data network can be bridged by this refinement of the invention.

### BRIEF DESCRIPTION OF THE DRAWINGS

These and other objects and advantages of the present invention will be explained in more detail with reference to an exemplary embodiment which relates to the processes that take place during the transmission of data from a first data network to a second data network., taken in conjunction with the accompanying drawings of which:

FIG. 1 is a structogram for a function INIT( ) for initialization of the data;

FIG. 2 is a structogram for a function SYNC( ) relating to synchronization;

FIG. 3 is a structogram for a function SAVE( ) relating to storage of a received data packet;

FIG. 4 is a structogram for a function READ( ) relating to reading and transmission of a stored data packet;

FIG. 5 is a structogram for a function MAKE_OUTBUF( ) which prepares data in an output buffer OUTBUF for transmission to the second data network.

FIG. 6 is a timing diagram showing the content of the payload information memory PPIM relating to the time SYS_TIME( )=78;

FIG. 7 is a timing diagram showing the content of the payload information memory PPIM relating to the time SYS_TIME( )=84;

FIG. 8 is a timing diagram showing the content of the payload information memory PPIM relating to the time SYS_TIME( )=90;

FIG. 9 is a timing diagram showing the content of the payload information memory PPIM relating to the time SYS_TIME( )=93;

FIG. 10 is a timing diagram showing the content of the payload information memory PPIM relating to the time SYS_TIME( )=107;

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The variables and functions used in the figures are listed in the following table, including the abbreviated designation of the full English-language name, the German-language title and, where applicable, a brief explanation, in each case separated by semi-colons:

```
SYS_TIME( ); system_time; Systemzeit
MAKE_OUTBUF( ); make_output_buffer; Ausgabebuffererzeugung;
      Produces the output buffer OUTBUF
CUT( ); cut_data; Ausschneiden; deletes data packets from the output buffer
      OUTBUF.
INSERT( ); insert_data; Einfügen; inserts synthetically generated data packets into the
      output buffer OUTBUF.
SEND( ); send_data; Senden; transmits the data contained in the output buffer
      OUTBUF to the second data network.
DECODE( ); decode; Dekodieren; depending on the standard being used, data is, for
      example, transmitted from the payload information memory PPIM to the buffer
      store SMPBUF, or data in the buffer store SMPBUF is produced synthetically
      with the aid of the data contained in the payload information memory PPIM.
L2T( ); length_to_time; length of the payload data converted to the time duration; this
      is described, for example, in “IETF RFC 1889, RTP: A Transport Protocol for
      Real-Time Applications”.
ABS( ); absolute; Absolutbetrag; supplies the absolute magnitude of the transferred
      argument.
MIN( ); minimum; Minimum; supplies the minimum of all the transferred arguments.
OUTBUF; output_buffer; Ausgabepuffer; buffer in which the data is produced for the
      second network.
OUTBUF.LEN; output_buffer_length; Ausgabepufferlänge; contains the time interval
      which is represented by the data contained in the output buffer OUTBUF.
OUTBUF.WRITE( ); write_output_buffer; Ausgabepuffer-schreibfunktion;
      writes data to the output buffer OUTBUF and increases the output buffer
      length OUTBUF.LEN.
OUTBUF.READ( ); read_output_buffer; Ausgabepufferlesefunktion; reads data from
      the output buffer OUTBUF and reduces the output buffer length
OUTBUF.LEN.
SMPBUF; sample_buffer; Zwischenpuffer; buffer which is used for production of
      the data in the output buffer OUTBUF.
SMPBUF.LEN; output_sample_length; Zwischenpufferlänge; contains the time
      interval which is represented by the data contained in the buffer store
      SMPBUF.
SMPBUF.WRITE( ); write_sample_buffer; Zwischenpufferschreibfunktion; writes
      data to the buffer store SMPBUF and increases the buffer store length
      SMPBUF.LEN.
SMPBUF.READ( ); read_sample_buffer; Zwischenpufferlesefunktion; reads data
      from the buffer store SMPBUF and decreases the buffer store length
      SMPBUF.LEN.
SCF; scaling_factor; Skalierungsfaktor; indicates the ratio of the memory size to
      the time duration of the payload data.
T_OUT; time_output; Ausgabezeitspanne; time interval which is intended to be
      output by the function SEND( ).
T_REST; rest_time; Restzeit; time interval for which data is intended to be written
      to the output buffer OUTBUF.
T_SMPBUF; sample_buffer_time; time interval for which data is intended to be
      read from the buffer store SMPBUF.
NUP; number_unread_packets; the number of packets which have not yet been
      read.
RFP; read_first_packet; Leseindikator; Boolean variable, whose value is TRUE
      when a first packet has been read and transmitted.
SFP; save_first_packet; Speicherindikator; Boolean variable, whose value is
      TRUE when a first packet has been received and stored.
TFP; time_first_packet; reception time of the first packet.
THR1; threshold1; erster Schwellwert; switching threshold for calling the function
      SYNC( ) —selected externally.
THR2; threshold2; zweiter Schwellwert; switching threshold for the start of the
      time compensation in the function READ( ) - selected externally.
SD; synchronisation_done; Synchronisierungsindikator; Boolean variable, TRUE
      when the function SYNC( ) has been called.
DR_ACT; delay_receive_actual; aktuelle Empfangsverzögerung; delay time
      between the time stamp for the received packet and the system time
      relating to the reception time.
DR_AVG; delay_receive_average; durchschnittliche Empfangsverzögerung;
      average value of DR_ACT.
DR_NOM; delay_receive_nominal; nominelle Empfangsverzögerung; nominal
      value for DR_AVG.
L_AVG; length_average; Durchschnitsslänge; determines the length of the
      average value formation from DR_AVG - selected externally.
DIO_ACT; delay_in_out_actual; aktuelle Ein-/Ausgangsverzögerung; delay time
      between the time stamp for the received packet and the system time
      relating to the output time.
DIO_NOM; delay_in_out_nominal; nominelle Ein-/Ausgangsverzöbgerung; nominal
      value for DIO_ACT - selected externally.
DIO_DIFF; delay_in_out_difference; Ein-/Ausgangs-verzögerungsdifferenz;
      difference between DIO_ACT and DIO_NOM, limited to the value
      DIO_STEP.
DIO_STEP; delay_in_out_step; Ein-/Ausgangsverzögerungsstufe; magnitude of
      the input/output delay which can be compensated for in one adaptation
      step - selected externally.
TS_ACT; timestamp_actual; aktueller Zeitstempel
SN_ACT; sequence_number_actual; aktuelle laufende Nummer
NP; new_packet; neues Paket
      NP.SN; sequence_number; laufende Nummer
      NP.PT; payload_type; Nutzdatentyp
      NP.PLEN; payload_length; Nutzdatenlänge
      NP.TS; timestamp; Zeitstempel
      NP.PL; payload; Nutzdaten
PHIM; packet_header_input_memory; Kopfinformationsspeicher
      PHIM.SN; sequence_number; laufende Nummer
      PHIM.PT; payload_type; Nutzdatentyp
      PHIM.PLEN; payload_length; Nutzdatenlänge
      PHIM.TS; timestamp; Zeitstempel
      PHIM.PTR; pointer; Nutzdatenzeiger
PHIM_IDX; packet_header_input_memory_index; Kopfinformationsspeicherindex
PHIM_LEN; packet_header_input_memory_length; Kopf-
      informationsspeicherlänge
PPIM; packet_payload_input_memory; Nutzinformationsspeicher
      PPIM.PL; payload; Nutzdaten
PPIM_IDX; packet_payload_input_memory_index; Nutzinformationsspeicherindex
PPIM_LEN; packet_payload_input_memory_length; Nutzinformationsspeicherlänge
```

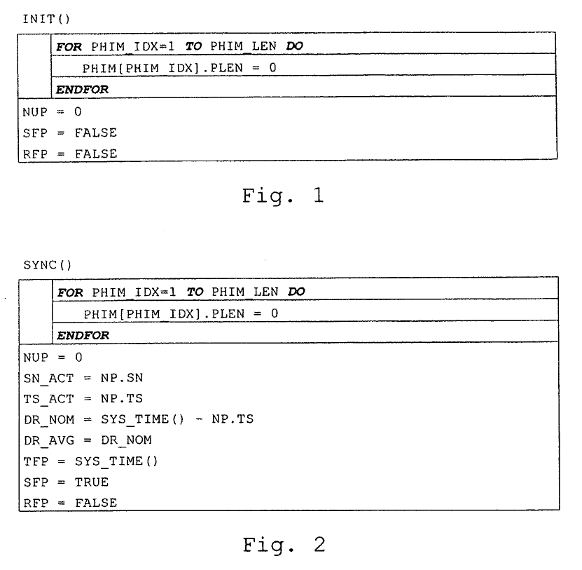

FIG. 1 shows a structogram for the function INIT( ). The payload data length PLEN in the header information memory PHIM with the header information memory index PHIM_IDX is in each case set to 0 in a loop, with the header information memory index PHIM_IDX assuming all the values from 1 to the header information memory length PHIM_LEN.

Furthermore, the number of packets NUP which have not yet been read is set to 0 and the memory indicator SFP and the read indicator RFP are initialized with the value FALSE.

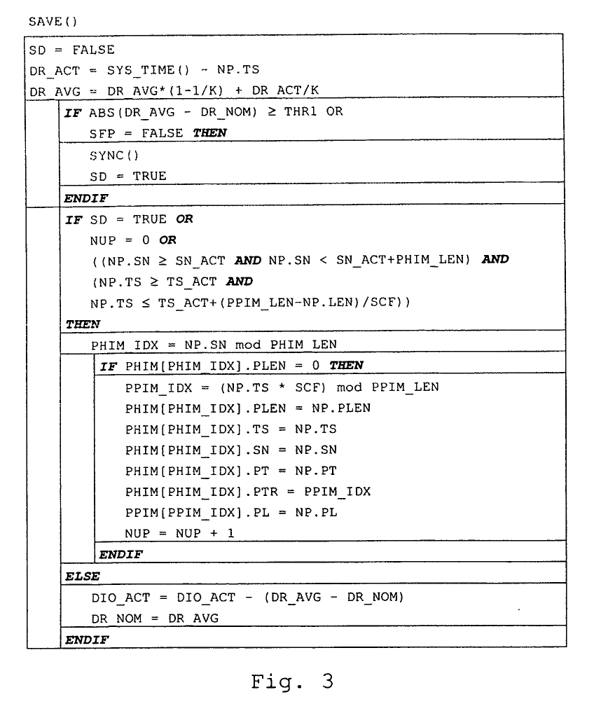

FIG. 2 shows a structogram for the function SYNC( ). The payload data length PLEN in the header information memory PHIM with the header information memory index PHIM_IDX is in each case set to 0 in a loop, with the header information memory index PHIM_IDX assuming all the values from 1 to the header information memory length PHIM_LEN.

Furthermore, the number of packets NUP which have not yet been read is set to 0 and the actual sequence number SN_ACT is initialized with the sequence number of the new packet NP.SN, and the actual time stamp TS_ACT is initialized with the time stamp for the new packet NP.TS. The nominal reception delay DR_NOM is calculated from the difference between the system time SYS_TIME( ) and the time stamp for the new packet NP.TS. The average reception delay DR_AVG is then set to be equal to the nominal reception delay DR_NOM, and the reception time for the first packet TFP is initialized with the system time SYS_TIME( ), the memory indicator SFP is initialized with the value TRUE, and the memory indicator RFP is initialized with the value FALSE.

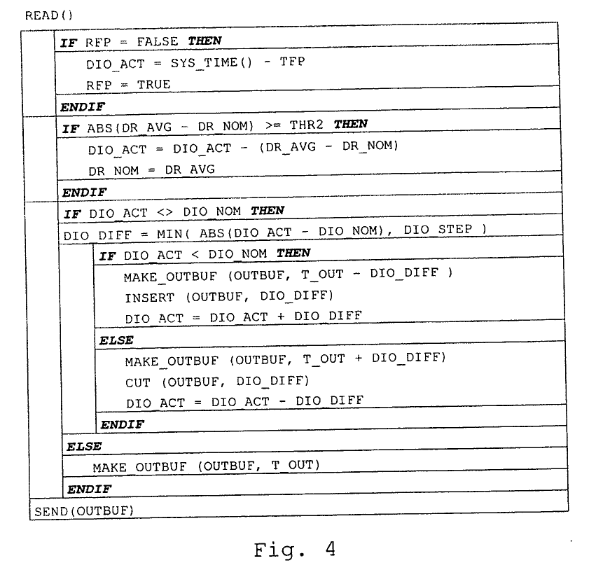

FIG. 3 shows a structogram for the function SAVE( ). Initially, the synchronization indicator SD is set to FALSE.

After this, the difference between the return value for the function system time SYS_TIME( ) and the time stamp for the new packet NP.TS is entered in the actual reception delay DR_ACT. Furthermore, the difference between 1 and the reciprocal of the average length L_AVG is formed, and is multiplied by the average reception delay DR_AVG. Subsequently, the actual reception delay DR_ACT divided by the average length L_AVG is added to this result, and the sum which results from this is transferred to the average reception delay DR_AVG.

A check is then carried out to determine whether, firstly, the absolute magnitude ABS( ) of the difference between the average reception delay DR_AVG and the nominal reception delay DR_NOM is greater than or equal to the first threshold value THR1 and, secondly, whether the memory indicator SFP contains the value FALSE. If the first or the second condition is satisfied, then the function SYNC( ) is called, and the synchronization indicator SD is then set to TRUE.

A further check is carried out to determine whether, firstly, the synchronization indicator SD is set to TRUE, secondly, whether the number of packets NUP which have not yet been read is equal to 0, and thirdly, whether the sequence number of the new packet NP.SN is in the interval SN_ACT.SN_ACT+PHIM_LEN−1, that is to say is greater than or equal to the actual sequence number SN_ACT and less than the sum of the actual sequence number SN_ACT and the header information memory length PHIM_LEN, and whether the time stamp for the new packet NP.TS is in the interval TS_ACT.TS_ACT+(PPIM_LEN-NP.PLEN)/SCF, that is to say is greater than or equal to the actual time stamp TS_ACT and is less than or equal to the sum of the actual time stamp TS_ACT and the difference between the payload information memory length PPIM_LEN and the payload data length of the new packet NP.PLEN divided by the scaling factor SCF. If one of the three conditions is satisfied, then a positive branch is followed, while a negative branch is followed if none of the three conditions is satisfied.

In the positive branch, the modulo operation is formed between the sequence number of the new packet NP.SN and the header information memory length PHIM_LEN, and the result is transferred to the header information memory index PHIM_IDX. A check is then carried out to determine whether the payload data length PLEN in the header information memory PHIM with the header information memory index PHIM_IDX is equal to 0.

If this inner condition is satisfied, then the modulo operation is formed between the product of the time stamp for the new packet NP.TS and the scaling factor SCF with the payload information memory length PPIM_LEN and the result is transferred to the payload information memory index PPIM_IDX. The time stamp TS, the sequence number SN and the payload data type PT in the header information memory PHIM with the header information memory index PHIM_IDX are then respectively set to the value of the time stamp TS, of the sequence number SN and of the payload data type PT of the new packet NP. The value of the payload information memory index PPIM_IDX is transferred to the payload data pointer PTR in the header information memory PHIM with the header information memory index PHIM_IDX. After this, the payload information PL in the payload information memory PPIM with the payload information memory index PPIM_IDX is set to be equal to the payload information in the new packet NP.PL.

Finally, the number of packets NUP which have not yet been read is incremented. At the same time, this is the final instruction for the conditional program execution in the positive branch, and is the final instruction for the inner condition.

In the negative branch, the difference between the average reception delay DR_AVG and the nominal reception delay DR_NOM is formed, is subtracted from the actual input/output delay DIO_ACT, and the result of this operation is transferred to the actual input/output delay DIO_ACT. Finally, the nominal reception delay DR_NOM is set to be equal to the average reception delay DR_AVG. This at the same time represents the final instruction for conditional program execution in the negative branch, and the final instruction for the function SAVE( ).

FIG. 4 shows a structogram for the function READ( ). First of all, a check is carried out to determine whether the read indicator RFP is set to FALSE. If this is the case, then the difference between the system time SYS_TIME( ) and the reception time of the first packet TFP is formed, and is transferred to the actual input/output delay DIO_ACT. The read indicator RFP is then set to TRUE. This is the end of conditional execution.

Furthermore, the absolute magnitude ABS( ) of the difference between the average input delay DR_AVG and the nominal input delay DR_NOM is formed. If this magnitude is greater than or equal to a second threshold value THR2, the difference between the average reception delay DR_AVG and the nominal reception delay DR_NOM is formed, is subtracted from the actual input/output delay DIO_ACT, and the result of this operation is transferred to the actual input/output delay DIO_ACT. Finally, the nominal reception delay DR_NOM is set to be equal to the average reception delay DR_AVG. This is the end of conditional execution.

A further check is carried out to determine whether the actual input/output delay DIO_ACT is not equal to the nominal input/output delay DIO_NOM. If this outer condition is satisfied, the input/output delay difference DIO_DIFF is formed from the minimum MIN( ) of DIO_STEP, and the absolute magnitude ABS( ) of the difference between the actual input/output delay DIO_ACT and the nominal input/output delay DIO_NOM is formed. A further check is carried out to determine whether the actual input/output delay DIO_ACT is less than the nominal input/output delay DIO_NOM. If this condition is satisfied, a positive branch is taken, otherwise a negative branch.

In the positive branch, the output buffer production MAKE_OUTBUF( ) is called in which case, in the illustrated example, the output buffer OUT_BUF and the output time interval T_OUT, reduced by the input/output delay difference DIO_DIFF, are transferred symbolically. The insertion function INSERT( ) is then called, with the output buffer OUT_BUF and the input/output delay difference DIO_DIFF being transferred symbolically in the illustrated example. The actual input/output delay DIO_ACT is then increased by the value of the input/output delay difference DIO_DIFF.

In the negative branch, the output buffer production MAKE_OUTBUF( ) is called, with the output buffer OUT_BUF and the output time interval T_OUT, increased by the input/output delay difference DIO_DIFF, being transferred in this case. The cut function CUT( ) is then called. The output buffer OUT_BUF and the input/output delay difference DIO_DIFF are transferred in this case, as symbolic transfer parameters. The actual input/output delay DIO_ACT is then reduced by the value of the input/output delay difference DIO_DIFF. This ends the execution of the inner condition.

If the outer condition is not satisfied, the output buffer production MAKE_OUTBUF( ) is called, with the output buffer OUT_BUF and the output time interval T_OUT being transferred symbolically. This at the same time represents the final instruction for the conditional branch.

As the final step of the function READ( ), the data which is temporarily stored in the output buffer OUTBUF is transmitted with the aid of a send function SEND( ) to the second data network, with the output buffer OUTBUF( ) being transferred to the send function SEND( ) symbolically in the illustrated example.

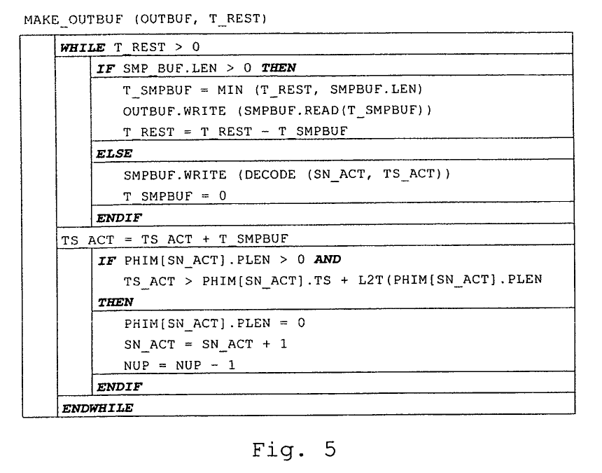

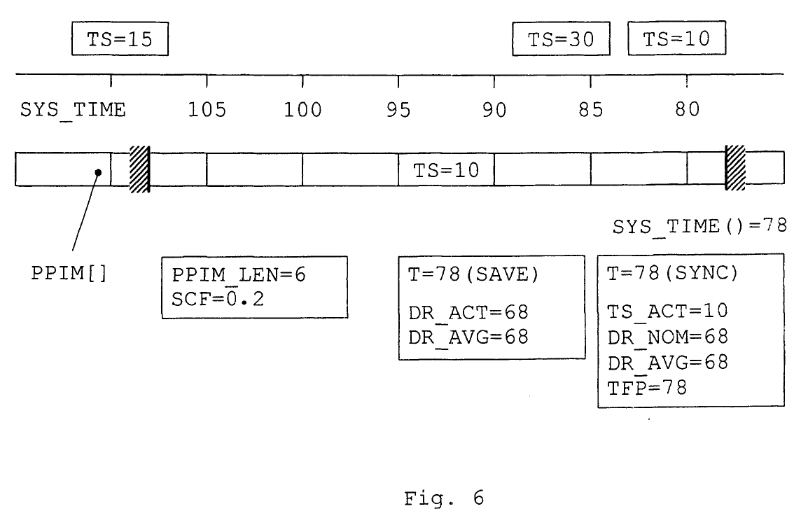

FIG. 5 shows a structogram for the function MAKE_OUTBUF( ). In this function, the value of the transferred time interval is first of all transmitted to the remaining time T_REST. The output buffer OUTBUF which is transferred as a parameter is in this example used for transferring the result of the function MAKE_OUT( ) to the calling function, and is not used at this point.

The loop body which is described in the following text is carried out repeatedly as long as the remaining time T_REST is greater than 0.

At the start of the loop body, a check is carried out to determine whether the length of the buffer store SMPBUF is greater than 0. If the condition is satisfied, a positive branch is taken, otherwise a negative branch.

In the positive branch, the minimum MIN( ) is first of all formed from the remaining time T_REST and the length of the buffer store SMP_BUF.LEN, and the result is stored in the buffer store time interval T_SMPBUF. After this, the number of data packets which corresponds to the buffer store time interval T_SMPBUF is transferred from the buffer store SMPBUF to the output buffer OUTBUF, with the read function SMPBUF.READ( ) for the buffer store SMPBUF and the write function OUTBUF.WRITE( ) for the output buffer OUTBUF being called symbolically. Finally, the remaining time T_REST is reduced by the value of the buffer store time interval T_SMPBUF.

In the negative branch, the payload PL of a data packet is first of all read from the memory device PPIM, is processed with the aid of the decoding function DECODE( ) for transmission to the second data network, and the result is stored in the buffer store SMPBUF, with the write function SMPBUF.WRITE for the buffer store SMPBUF being called symbolically. The buffer store time T_SMPBUF is then initialized with the value 0. This at the same time represents the final instruction for conditional execution.

The decoding function DECODE( ) in the illustrated example is used to convert data from a format that is used in the first network to a format that is used in the second network. Examples of a function such as this are known, for example, from the standards mentioned in the introduction. In one simple case, the temporarily stored samples are read from the memory device and are transferred without being changed to the buffer store SMPBUF. However, it is also feasible for only information to have been received via a signal from the first data network and that only a signal for the second data network need be generated from this information. Instead of having to transmit a sinusoidal signal in the form of individual sample values, this may be done, for example, by transmission of a frequency and amplitude. The sinusoidal signal is itself generated once again from this information with the aid of the decoding function DECODE( ).

In a further execution step in the loop body, the time stamp TS_ACT is increased by the buffer store time T_SMPBUF.

After this, a check is carried out to determine whether the payload data length PLEN in the header information memory PHIM with the actual sequence number SN_ACT as the index is greater than 0, and whether the actual time stamp TS_ACT is greater than the sum of the time stamp TS in the header information memory PHIM with the actual sequence number SN_ACT as the index and the length of the payload data LOT( ) converted to the time duration. As the argument for the length of the payload data LOT( ) converted to the time duration, the payload data length PLEN in the header information memory PHIM with the actual sequence number SN_ACT as the index is transferred symbolically in this case.

If the condition is satisfied, then the payload data length PLEN in the header information memory PHIM with the actual sequence number SN_ACT as the index is set to 0, the actual sequence number SN_ACT is increased by 1, and the number of packets NUP which have not yet been read is reduced by 1. This at the same time represents the final instruction for conditional program execution, and the final instruction for the function MAKE_OUTBUF( ).

The operation of the exemplary embodiment illustrated in the figures is as follows.

At the start of the method, the function INIT( ) is called, and is used to initialize essential variables.

When a data packet arrives, the function SAVE( ) is called, with the content of the data packet which has arrived having already been stored in the new packet NP. This step is not illustrated in the figures.

At the start of the function SAVE( ), the actual reception delay DR_ACT and the average reception delay DR_AVG are recalculated.

If the data packet is the first arriving packet or if the difference between the average reception delay DR_AVG and the nominal reception delay DR_NOM is greater than or equal to the first threshold value THR1, whose definition is not a part of the exemplary embodiment, then the function SYNC( ) is called. The object of this is essentially to initialize specific variables but, in contrast to the function INIT( ), may be called more than once.

If the memory space to be occupied by the new packet NP is still available in the header information memory PHIM and in the payload information memory PPIM, the new packet NP is stored at the appropriate location. The position within the header information memory PHIM and within the payload information memory PPIM is in this case determined with the aid of the time stamp and the sequence number of the new packet NP.TS and NP.SN. The header information memory PHIM and the payload information memory PPIM in the illustrated example are organized as ring memories with a fixed size. The new packets NP are in this case stored in the sequence in which they were output, to be precise with the header information sorted on the basis of the sequence number of the new packet NP.SN in the header information memory PHIM, and the payload information being sorted on the basis of the time stamp for the new packet NP.TS in the payload information memory PPIM. Furthermore, the number of packets NUP which have not yet been read is increased by 1.

If it has not been possible to arrange the new packet NP in the header information memory PHIM and in the payload information memory PPIM, then the values for the actual input/output delay DIO_ACT and for the nominal reception delay DR_NOM are recalculated.

The function READ( ) is called at fixed predetermined times, with the choice of the times not being part of the exemplary embodiment illustrated in the figures.

When the function READ( ) is first called, the actual input/output delay DIO_ACT is initialized. On the assumption that the second threshold value THR2 has not been exceeded and that the actual input/output delay DIO_ACT is less than the nominal input/output delay DIO_NOM, the value for the input/output delay difference DIO_DIFF is formed as the next step. After this, the function MAKE_OUTBUF( ), is called, which produces payload data for the output time interval T_OUT reduced by the input/output delay difference DIO_DIFF in the output buffer OUTBUF. Further data for the time interval which is represented by the input/output delay difference DIO_DIFF is then also produced synthetically with the aid of the insertion function INSERT( ), and is likewise passed to the output buffer OUTBUF( ). In the situation where the actual input/output delay DIO_ACT is greater than the nominal input/output delay DIO_NOM, the data would in contrast be deleted from the output buffer OUTBUF once again, using the cut function CUT( ). The aim of the insertion function INSERT( ) and of the cut function CUT( ) is thus to match the actual input/output delay DIO_ACT to the nominal input/output delay DIO_NOM. If the actual input/output delay DIO_ACT is equal to the nominal input/output delay DIO_NOM, on the other hand, there is no need for any further insertion or cut process. Once the output buffer OUTBUF has been processed appropriately, it is transmitted to the second data network using the send function SEND( ).

Neither the send function SEND( ) nor the choice of the nominal input/output delay DIO_NOM is a part of the exemplary embodiment.

When the output buffer production MAKE_OUTBUF( ) is called, on the assumption that the time interval which has passed and thus the remaining time T_REST are greater than 0 and that the buffer store length SMPBUF.LEN is equal to 0, data is produced in the buffer store SMPBUF with the aid of the decoding function DECODE( ), for example the data for a so-called frame. The function SMPBUF.WRITE in this case increases the buffer store length SMPBUF.LEN.

If the packet in the header information memory PHIM with the index of the actual sequence number SN_ACT is no longer required, the corresponding memory area is then released in the header information memory PHIM. Furthermore, the actual sequence number SN_ACT and the number of packets NUP which have not yet been read are updated.

Since the remaining time T_REST was not changed in the first run through the loop and is thus greater than 0, the buffer store time T_SMPBUF is now determined in the second run through the loop. As the next step, data corresponding to the buffer store time T_SMPBUF is read from the buffer store SMPBUF with the aid of the function SMPBUF.READ( ) and is transferred to the output buffer OUTBUF with the aid of the function OUTBUF.WRITE( ). The buffer store length SMPBUF.LEN and the output buffer length OUTBUF.LEN are in this case matched by the function SMPBUF.READ( ), and by the function OUTBUF.WRITE( ), respectively. The remaining time T_REST is then recalculated.

The present example is based on the assumption that it has already been possible to enter data corresponding to the time interval that had been passed in the output buffer OUTBUF during the second run through the loop. The output buffer production MAKE_OUTBUF( ) is thus closed at this point. Otherwise, the loop body is passed through until all of the required data has been entered in the output buffer OUTBUF.

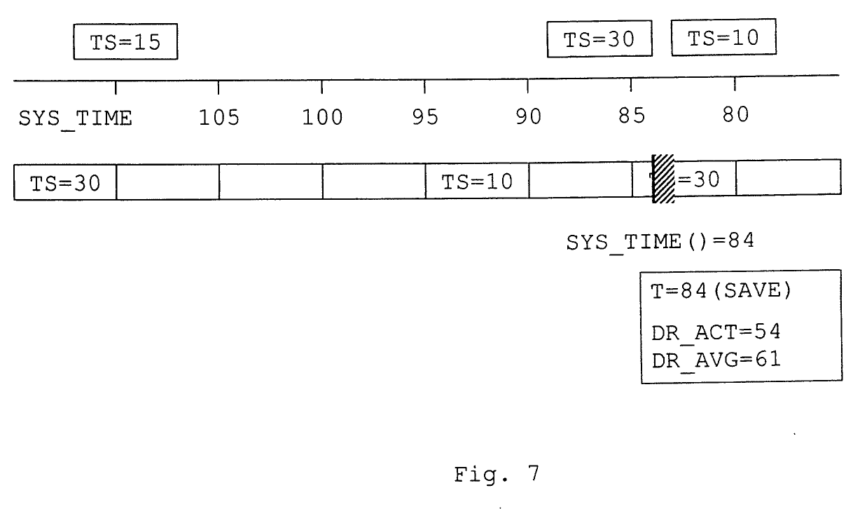

FIG. 6 shows the content of the payload information memory PPIM at the time SYS_TIME( )=78. The arrival of the packets to be received is indicated by a time beam, on which the system time SYS_TIME( ) is plotted in the range from 75 to 115. The time unit is in this case ignored in this representation. A first packet with the time stamp TS=10 arrives at the time 78, a second packet with the time stamp TS=30 arrives at the time 84, and a third packet with the time stamp TS=15 arrives at the time 107, with the apparatus according to the invention. The packets, which each contain data for the time period 5, are thus arranged on the time beam on the basis of their time ranking. The payload information memory PPIM is shown underneath this and, in the illustrated example, is organized as a ring memory with the payload information memory length PPIM_LEN=6. Since the length of a data packet is 5 in this case, the scaling factor SCF is 0.2. By way of example, the value 2 is chosen in this case for the average length L_AVG. The shaded area of the payload information memory PPIM indicates the proportion of the time which has already passed. Parameters which are relevant for the state of the apparatus are also illustrated.

The content of FIGS. 7 to 10 corresponds to that of FIG. 6, but showing the system at different times.

The procedure for the transmission process which leads to the states illustrated in FIGS. 6 to 10 is as follows.

The first packet with the time stamp TS=10 arrives at the apparatus according to the invention at the time SYS_TIME( )=78. The function SAVE( ) is called in order to store the packet. Since the memory indicator SFP contains the value FALSE at this time, the function SYNC( ) is carried out initially. The time to carry out the process steps in the example is generally assumed to be 0, that is to say, in this idealized representation, a process step thus follows a previous process step without any delay.

FIG. 6 shows values for relevant parameters after the function SYNC( ) has been carried out at the time T=78(SYNC). The actual time stamp TS_ACT was set to 10, the nominal reception delay DR_NOM was set to 68, the average reception delay DR_AVG was likewise set to 68, and the reception time for the first packet was set to 78. Since all the conditions for storage of the packet are satisfied, the first packet is stored with the time stamp TS=10, although the figure illustrates only the payload information memory PPIM.

It is possible for the payload information memory PPIM to be initialized on arrival of the first packet, starting with the payload information memory index PPIM_IDX=0. The memory position for the first packet is thus obtained from PPIM_IDX=(NP.TS*SCF) mod PPIM_LEN for PPIM_IDX=(10*0.2) mod 6=2.

FIG. 6 also shows values of relevant parameters after carrying out the function SAVE( ) at the time T=78(SAVE).

The actual reception delay DR_ACT and the average reception delay DR_AVG were set to 68.

The second packet with the time stamp TS=30 arrives at the apparatus according to the invention at the time SYS_TIMEO=84. The function SAVE( ) is called once again in order to store the packet. Since the memory indictor SFP already contains the value TRUE, however, at this time, the function SYNC is no longer carried out. Since all of the conditions for storage of the packet are satisfied, the second packet is stored at the position provided for this purpose with the time stamp TS=30, with the packet being illustrated twice in the figure, for the sake of completeness, since the payload information memory PPIM is a ring memory.

FIG. 7 also shows values for relevant parameters after the function SAVE( ) has been carried out at the time T=84(SAVE). The actual reception delay DR_ACT was set to 54, and the average reception delay DR_AVG was set to 61.

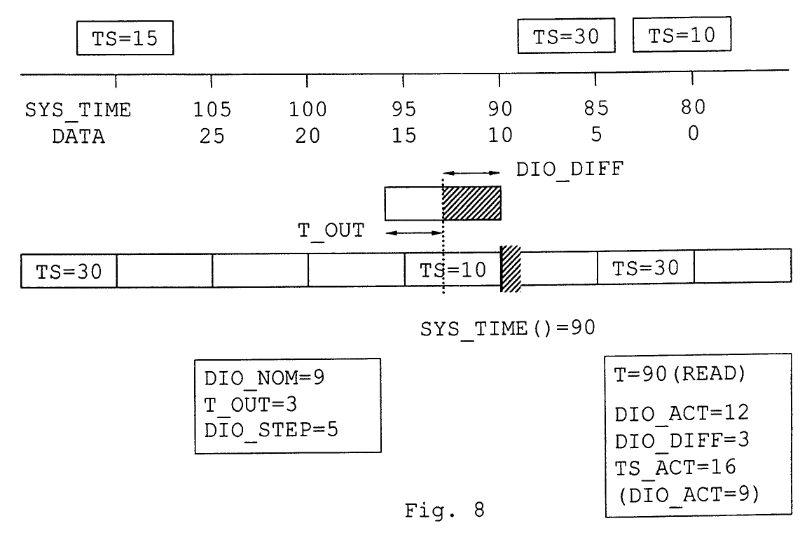

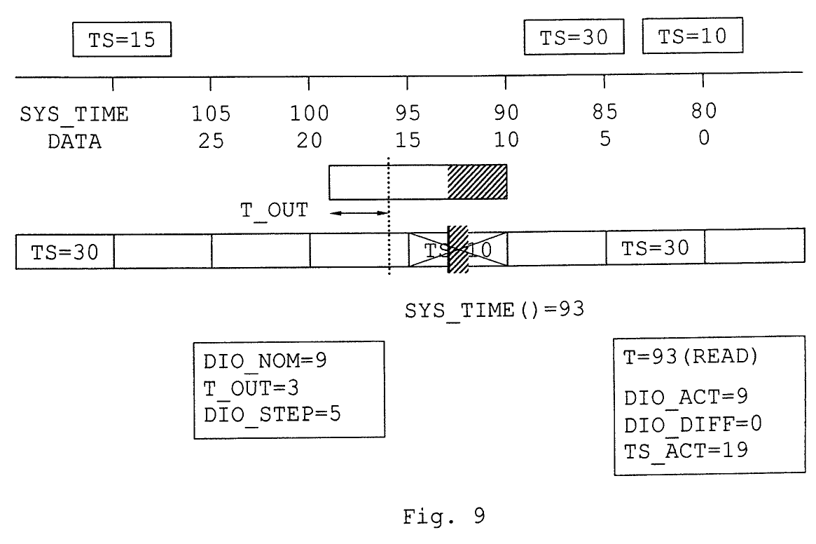

FIG. 8 shows the system at the time SYS_TIME( )=90. The illustrated example is based on the assumption that the function READ( ) is called for the first time at this time, and is then called repeatedly at the interval 3 again, corresponding to the output time interval T_OUT=3. The nominal input/output delay DIO_NOM is assumed to be 9, and the input/output delay step DIO_STEP is assumed to be 5.

Since the read indicator RFP contains the value FALSE at the time T=90, the actual input/output delay DIO_ACT is set to 12. The value for the input/output delay difference DIO_DIFF is thus 3. The function of output buffer production MAKE_OUTBUF( ) thus rejects the data for the time interval DIO_DIFF=3, and then starts to read data for the time interval T_OUT=3, and to produce this in the output buffer OUTBUF. The data output therefore starts at the time T=90, starting at the time T=13 which is related to the data.

The rejected data is illustrated in a shaded form in FIG. 8, while the data that is read is unshaded. The dashed line represents the pointer to the data to be output at that time and is shifted continuously to the left, in the same way as the line for the actual system time. The read pointer, which is represented by the dashed line and is related to the time scale DATA indicates the value 13, while the system time SYS_TIME( ) indicates the value 90.

After calling the output buffer production MAKE_OUTBUF( ), the actual time stamp TS_ACT is set to 16, and the actual input/output delay DIO_ACT is set to 9. Since the conditions for this are satisfied, the first packet with the time stamp TS=10 is deleted from the payload information memory PPIM at the end of the function READ( ).

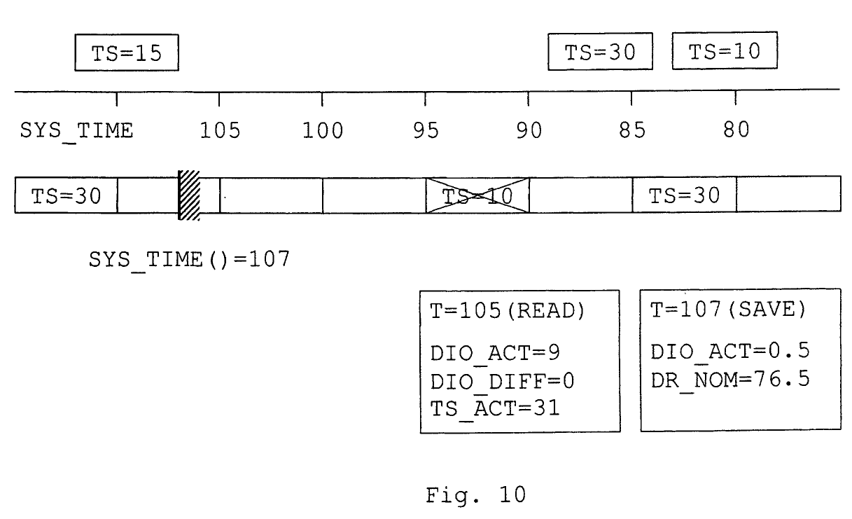

FIG. 9 shows the apparatus according to the invention at the time SYS_TIME( )=93. Since the first packet with the time stamp TS=10 has been deleted in the meantime, this is represented here with a line through it. The actual input/output delay DIO_ACT at this time is 9. The input/output delay difference DIO_DIFF is thus 0, and further data for the time interval T_OUT=3 is read by the output buffer production MAKE_OUTBUF( ) and is output. The read pointer relating to the time SYS_TIME( )=93 indicates the value T=19.

FIG. 10 shows the system relating to the time SYS_TIME( )=107. Immediately before this, the function READ( ) relating to the time T=105 was called for the final time. The values resulting from this are indicated for T=105(READ). In this case, the actual input/output delay was set to 9, the input/output delay difference was set to 0, and the actual time stamp TS_ACT was set to 31.

The third packet, which was received at the time T=107 and has the time stamp TS=15 does not satisfy the conditions contained in the function SAVE( ) in the payload information memory PPIM, and is thus rejected. After carrying out the function SAVE( ), the actual input/output delay DIO_ACT relating to the time T=107(SAVE) thus has the value 0.5, while that for the nominal reception delay DR_NOM has the value 76.5. The comparatively late arrival of the third packet results in the nominal reception delay DR_NOM being adapted from 68 to 76.5, taking account of the fact that the third packet can no longer be stored and output owing to the time which has passed.

The exemplary embodiment which is illustrated in the figures indicates only one of a number of possible ways to transmit data on the basis of the method according to the invention. However, it is significant in this case that the read pointer can be positioned at any desired point in the memory without in the process having to be linked to the boundaries that are formed by the individual packets.

The invention has been described in detail with particular reference to preferred embodiments thereof and examples, but it will be understood that variations and modifications can be effected within the spirit and scope of the invention.

1-10. (cancelled)

11. A method for transmission of data from a first data network to a second data network, where the data in the first data network is subdivided into packets, comprising:
storing in each data packet payload data and information about a time sequence which is provided in the second data network;
temporarily storing the data packets in a memory device based on the time sequence; and
reading the data packets which have been temporarily stored, starting with a predetermined data packet at a starting point located at any desired point in a data packet.

12. The method as claimed in claim 11,
wherein the data is transmitted to the second data network at a time which is defined by adding a predetermined delay time to a time ranking of the data, and
wherein the starting point for said reading of the data packets temporarily stored in the memory device is chosen based on the predetermined delay time.

13. The method as claimed in claim 2, wherein data is produced synthetically when the calculated time for the transmission of the data is in the future with respect to the actual system time and there is no data with this time ranking in the temporary memory.

14. The method as claimed in claim 13,
wherein the delay time is shortened when a data packet is received too late to allow it to be temporarily stored, and
wherein the delay time is lengthened when a data packet is received too early to allow it to be temporarily stored.

15. The method as claimed in claim 14,
wherein a packet has a time stamp and a sequence number,
wherein the memory device is configured with a number of parts,
wherein the header information for the data packets is stored in a header information memory, sorted on the basis of the sequence number of the data packets, and
wherein the payload data in the data packets is stored in a payload information memory, sorted on the basis of the time stamps for the data packets.

16. The method as claimed in claim 15,
wherein a magnitude is calculated for the time difference between the time stamp for a packet and the actual system time at which this packet is manipulated,
wherein a synchronization process is initiated when a threshold value which can be predetermined is exceeded on the basis of this magnitude, and
wherein the memory device is initialized during the synchronization process.

17. The method as claimed in claim 16,
wherein the difference between an average reception delay and a nominal reception delay is provided as the magnitude for initiation of a synchronization process,
wherein the actual reception delay between the system time for the reception time of an arriving new packet and the time stamp for this new packet is determined, and
wherein the average reception delay is calculated over all of the actual reception delays as calculated in this way, for a number, which can be predetermined, of packets which have already arrived.

18. A system for transmission of data from a first data network to a second data network, where the data in the first data network is subdivided into packets, comprising:
an input module receiving from the first data network data packets containing payload data and information about a time sequence in the second data network;
an output module transmitting the data to the second data network;
a synchronization module;
a memory device temporarily storing the data packets based on the time sequence; and
a read apparatus reading the data packets which have been temporarily stored, starting with a predetermined data packet at a starting point located at any desired point in a data packet.

19. The system as claimed in claim 18, wherein said synchronization module adds a predetermined delay time to a time ranking of the data to control output of the data by said output module.

20. The system as claimed in claim 19, wherein said memory device includes
a header information memory storing header information for the data packets based on sequence numbering of the data packets; and
a payload information memory storing the payload data in the data packets based on time stamps of the data packets.
